(19) United States
(12) Patent Application Publication
(10) Pub. No.: US 2007/0267515 A1
(43) Pub. Date: Nov. 22, 2007

(54) Apparatus for monitoring and regulating soil moisture

(76) Inventor: Ronald J. Sargent, Fort Myers, FL (US)

Correspondence Address: CHARLES J. PRESCOTT, P.A., SUITE 115, 2033 WOOD STREET, SARASOTA, FL, 34237, US

(21) Appl. No.: 11/800,197

(22) Filed: May 4, 2007

Related U.S. Application Data
(60) Provisional application No. 60/801,361, filed on May 18, 2006.

(51) Int. Cl. B05B 12/08; A01G 27/00

(52) U.S. Cl. 239/63; 239/67; 239/69

(57) ABSTRACT

A water moisture sensing and watering apparatus including a housing having a water chamber that is at least partially evacuatable. A porous sensor is communicably connected to the chamber. When the moisture in the soil is sufficiently high, the pores of the sensor filled sufficiently to become plugged so that a vacuum or low-pressure region and water are maintained within the chamber. When the moisture of the soil drops below a predetermined level, the moisture in the pores is pulled out by the soil and plant roots sufficiently for air to be transmitted through the pores of the sensor into the chamber, increasing pressure in the chamber and providing an indication that water is needed in the soil and, in certain embodiments, automatic watering the soil and plant roots.

### CROSS-REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to an apparatus for monitoring soil moisture and, more particularly, to an apparatus for sensing when the soil supporting a plant requires watering and for automatically watering the plant when a sufficient lack of moisture is detected.

2. Description of Related Art

Virtually all plants require periodic watering. Providing the soil that supports a plant with the proper amount of water is very important. Applying too little or too much water may interfere with the growth of the plant or even kill the plant. Constantly monitoring the soil condition of the plant is usually tedious, time consuming and annoying. Oftentimes, the plant owner neglects this task and, as a result, plants suffer from lack of water. On the other hand, an inattentive plant owner may inadvertently over water the plant, which can be just as damaging. Even if the soil condition of the plant is properly monitored, it can be often difficult to accurately judge precisely how much watering is required. This results in guesswork which can lead to either underwatering or over watering and the harmful consequences described above.

Even if performed at proper intervals, hand-watering plants can be tedious and time consuming. Although many types of automatic watering systems are known, these tend to be fairly complicated and expensive. Many are only suitable for outdoor or green house use or for use with large numbers of plants. Most conventional automatic watering systems are not appropriate for use with potted plants or a small number of plants.

As additional problem with conventional automatic watering systems is that many of these devices are time dependent and a plant's need for water is often not solely a function of time. Typically, the plant's demand for water varies with the condition of the soil, the atmospheric temperature, the humidity, etc. Accordingly, Lohoff, U.S. Pat. No. 3,916,678, discloses a device for detecting when the soil supporting a plant is sufficiently dry to indicate that the plant needs to be watered. One device disclosed by Lohoff simply provides a visual indication that the soil is dry and requires watering. This apparatus employs a fairly complicated construction with a number of small parts including a flexible diaphragm, a coil spring and a protruding check valve. The numerous parts and relatively high cost of manufacturing this item renders it commercially impracticable. Lohoff also discloses various items that automatically dispense water when the sensed soil moisture is sufficiently low. However, typically these devices provide for only a single watering. Water is not repeatedly provided to the soil as needed. Rather, each time the water is automatically dispensed, it must be manually replenished. This is time consuming and inconvenient.

Other related prior art devices are disclosed in U.S. Pat. No. 4,274,583 to Hunter teaching a complicated moisture and pressure responsive irrigation system, in U.S. Pat. No. 5,596,839 to Ellis-El disclosing self-feeding planter, and in U.S. Pat. No. 6,198,398 invented by Velasquez teaching a soil moisture monitoring device which emits a variable frequency LED advising of soil moisture/dryness levels.

### BRIEF SUMMARY OF THE INVENTION

This invention is directed to an apparatus for monitoring the moisture of soil supporting a plant. The apparatus includes a housing having an evacuatable air chamber for accommodating a vacuum or at least a low pressure region therein. As used herein “vacuum” should be understood to include at least a partial vacuum and “low pressure” should be understood to mean sub-atmospheric pressure. A porous sensor is attached to the housing in communication with the air chamber. The sensor mechanism is introducible into the soil supporting the plant having a porosity that attracts soil moisture to the element and which permits the attracted soil moisture to be removed from the sensor by the soil when soil dryness increases moisture tension above a predetermined level. With the chamber in an evacuated or low pressure condition and with moisture accumulated in the pores of a sensor, the pores of the sensor are plugged to maintain the vacuum or low pressure condition in the chamber. When the soil moisture tension exceeds the predetermined level, the water is drawn from the pores of the sensor by the soil to unplug the pores. This causes air to enter the chamber through the porous sensor and eliminate the vacuum or low pressure region. An indication is thereby provided that the soil is dry and that the plant requires watering.

In one embodiment, the housing includes a resiliently collapsible bulb that is attached directly and communicably to the sensor such that the sensor communicates with the chamber, which is formed within the bulb. An indicator element may be carried by the bulb extending from an upper end thereof. The sensor may be attached to an opposite lower end of the bulb. The bulb may carry a check valve, which may comprise a slit in the bulb. More specifically, the bulb may carry a generally annular rib that circumferentially surrounds the bulb. The slit may be formed in the rib to define the check valve.

Initially, the chamber is evacuated by depressing the indicator element downwardly such that the upper end of the bulb deflects into the chamber. Air is evacuated through the check valve and/or through the porous sensor carried by the bulb. The sensor may then be introduced into the soil. When the soil contains adequate moisture to provide water to the plant, the sensor pulls water from the soil into the pores of the sensor by capillary action. This water plugs the pores and holds the chamber of the bulb in a pressure reduced, evacuated condition. The check valve remains closed so that air does not enter the chamber through the wall of the bulb. Eventually, the soil dries sufficiently until the soil moisture tension of the soil pulls the moisture held in the sensor out of the pores. This opens the pores and allows air to enter the bulb. The upper end of the bulb expands upwardly and the indicator projects from the bulb to indicate that the plant needs to be water.

In an alternative embodiment, the housing comprises a bellows shaped element that is seated in a support structure. The support structure may carry a disc shaped porous sensor that communicates with the chamber formed within the bellows. A check valve may be formed proximate the upper end of the bellows.

In another version of this invention, water is also dispensed automatically into the soil as needed. The housing may include an elongated tube that is at least partially filled with a supply of water. The interior of the tube defines the chamber. The tube may include a base at its lower end and a removable cap at its upper end for sealably closing the chamber such that a vacuum or low pressure region is created therein.

The porous sensor may be communicably connected through the base to an elongated conduit that extends through the chamber to a location proximate the cap and above the water within the tube. A dispensing conduit may be communicably connected to the chamber, typically through the base. When the pores of the sensor are plugged with water, as previously described, the low pressure region within the sealed chamber holds the water within the chamber and water is not dispensed through the dispensing conduit. However, when the soil is sufficiently dry such that the predetermined soil moisture tension is exceeded, the water within the pores is pulled out of the pores by the soil. This opens the pores and allows air to enter the low pressure region of the chamber through the sensor and the elongate conduit. This breaks the suction or vacuum within the chamber so that water is dispensed through the dispensing conduit. This occurs until the soil is moistened sufficiently that the soil moisture tension drops below the predetermined level and moisture is again pulled into the pores to plug the sensor. At that point, suction is again drawn within the chamber and no further water is dispensed.

The tubular housing may be transparent so that the water supply can be conveniently monitored. One or more supporting spikes or stakes may be carried by the housing to mount the apparatus in the soil with the sensor inserting into the soil.

Still another version of this invention features a float element that is mounted in the housing between upper and lower support members. Each of the upper and lower support members carries magnetic means; each end of the float element carries complementary magnetic means that releasably adhere to the magnetic means carried by the upper and lower support members respectively. An evacuatable air chamber portion is formed between the upper end of the float element and the upper support member. A water accumulating chamber is formed between the upper end of the float element and the lower support member. The porous sensor is connected communicably through the upper support member to the air chamber portion. The water chamber is connected to a dispensing conduit that extends through the lower support member. The water chamber portion is also connected through a valve to a water supply inlet.

When the soil is sufficiently moist and the pores of the sensor are plugged, a suction or vacuum is drawn on the air chamber, which prevents water within the water chamber from leaking out through the water dispensing conduit. The float element is supported by the water in the chamber and the upper magnetic means carried by the upper support member engages the magnetic means carried by the upper support member. This holds the float element in an elevated condition within the chamber and the float, in turn, holds the valve closed. As the pores of the sensor dry, air is introduced into the air chamber portion. This releases the low pressure of suction, which allows water to be dispensed through the dispensing conduit. The water level within the water chamber portion thereby drops. The weight of the float eventually causes the upper float magnetic means to disengage from the magnetic means of the upper support member. Eventually, the lower magnetic means of the float element engages the magnetic means of the lower support element such that the float element snaps down and again opens the valve so that water is introduced through the inlet conduit into the water chamber. A snap action is necessary to prevent leakage during a slow transition of the float and may also be provided within the scope of this invention by an over-center type spring. The water may be supplied from a gravity container, a regulated pressure source (e.g. the utility or municipality water source) or a pump. In this manner, water is replenished as required and the soil moisture is maintained automatically at a desired level. The upper support member may carry a check valve for evacuating air from the chamber as the water level and the level of the float element rise. An elongated conduit may communicably interconnect the sensor and the chamber. One or more elongated support members may secure the housing to the soil or be bent and shaped to hold the assembly on the rim of the pot or planter.

It is therefore an object of the present invention to provide an apparatus for monitoring soil moisture, which provides a prompt, reliable indication that the soil supporting a plant is dry and that the plant needs to be watered.

It is a further object of this invention to provide an improved apparatus for conveniently and automatically monitoring the moisture content of soil supporting a plant so that the plant may be properly watered.

It is a further object of this invention to provide an apparatus for monitoring soil moisture, which exhibits an improved, simplified and low-cost construction as well as an extremely reliable operation over repeated watering cycles.

It is a further object of this invention to provide an apparatus for monitoring soil moisture that accurately delivers an appropriate amount of water to a plant each time the plant requires such water.

It is a further object of this invention to provide an apparatus for monitoring soil moisture that delivers controlled amounts of water to the soil supporting a plant so that the plant is neither underwatered nor overwatered and so that proper plant growth is maintained.

It is a further object of this invention to provide an apparatus for monitoring soil moisture that significantly reduces the time, tedium and guesswork normally associated with monitoring the water needs of a plant.

It is a further object of this invention to provide an apparatus that is particularly effective for monitoring the soil moisture of potted planters and indoor plants.

In accordance with these and other objects which will become apparent hereinafter, the instant invention will now be described with reference to the accompanying drawings.

### BRIEF DESCRIPTION OF THE SEVERAL VIEWS OF THE DRAWING(S)

FIG. 1 is an elevational front view of an apparatus for monitoring soil moisture according to this invention.

FIG. 2 is a top plan view of the apparatus of FIG. 1.

FIG. 3 is a cross sectional view in the direction of arrows 3-3 in FIG. 2.

FIG. 4 is a view of FIG. 3 with the bulb in an actuated condition indicating that water is not required.

FIG. 5 is an elevational side view of an alternative monitoring apparatus.

FIG. 6 is a cross sectional view of the apparatus of FIG. 5 in an extended condition indicating that water is required.

FIG. 7 is a perspective view of an alternative monitoring apparatus, which automatically waters a plant when soil moisture conditions warrant.

FIG. 8 is an exploded perspective view of FIG. 7.

FIG. 9 is a perspective view of a sensor for holding moisture from soil and allowing passage of air therethrough when sufficiently dried.

FIG. 10 is a side elevation view of FIG. 9.

FIG. 11 is a view of area 11 in FIG. 10.

FIG. 12 is atop plan view of FIG. 9.

FIG. 13 is a perspective view of another plant watering apparatus in accordance with the present invention.

FIG. 13A shows an alternate embodiment of the apparatus of FIG. 13.

FIG. 13B shows an alternate embodiment of the apparatus of FIG. 13.

FIG. 14 is a front elevation view of FIG. 13.

FIG. 15 is a side elevation view of FIG. 13.

FIG. 16 is a section view in the direction of arrows 16-16 in FIG. 15.

FIG. 17 is a section view in the direction of arrows 17-17 in FIG. 14.

FIG. 18 is a side elevation view of still another soil moisture monitoring apparatus in accordance with this invention which supplies water as required to plants.

FIG. 19 is a front elevation view of FIG. 18.

FIG. 20 is an exploded view of FIG. 18.

FIG. 21 is a section view in the direction of arrows 21-21 in FIG. 18.

FIG. 22 is a section view in the direction of arrows 22-22 in FIG. 19.

FIG. 23 is an enlarged view of area 23 of FIG. 24.

FIG. 24 is an enlarged view of area 24 of FIG. 22.

FIG. 25 is an enlarged view of area 25 in FIG. 22.

FIG. 26 is a section view in the direction of arrows 26-26 in FIG. 28.

FIG. 27 is a section view in the direction of arrows 27-27 in FIG. 29.

FIG. 28 is a front elevation view of still another and preferred embodiment of a plant watering device in accordance with this invention.

FIG. 29 is a side elevation view of FIG. 28.

FIG. 30 is a perspective view of FIG. 28.

FIG. 31 is an enlarged view of area 31 in FIG. 26.

FIG. 32 is a pictorial view of an alternate and preferred embodiment of the invention shown in FIGS. 26 to 31 disposed within a potted plant.

FIG. 33 is a schematic view of a siphon overflow surge monitoring and watering system.

### DETAILED DESCRIPTION OF THE INVENTION

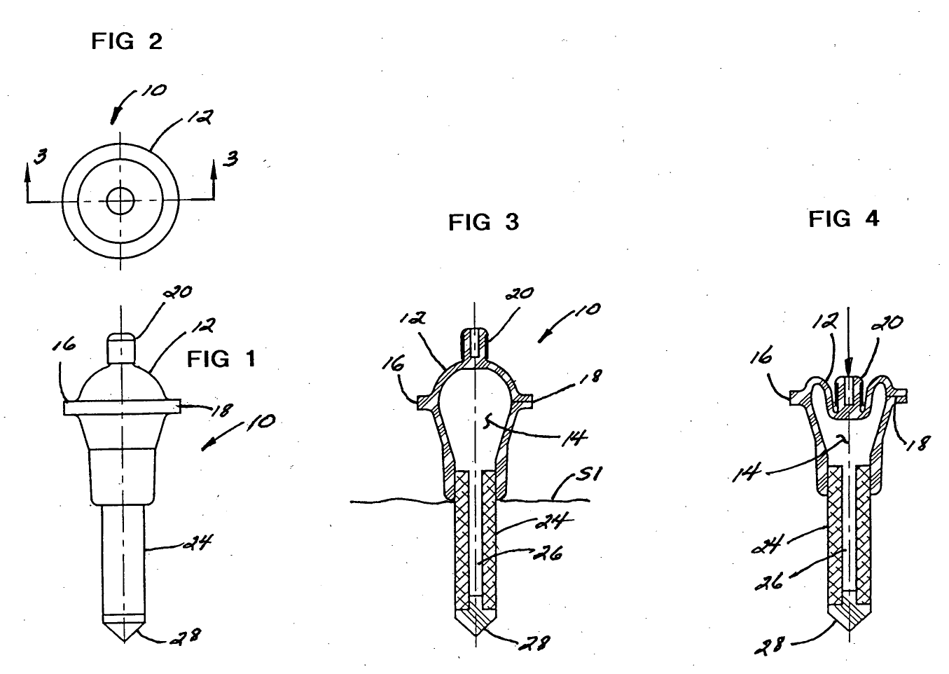

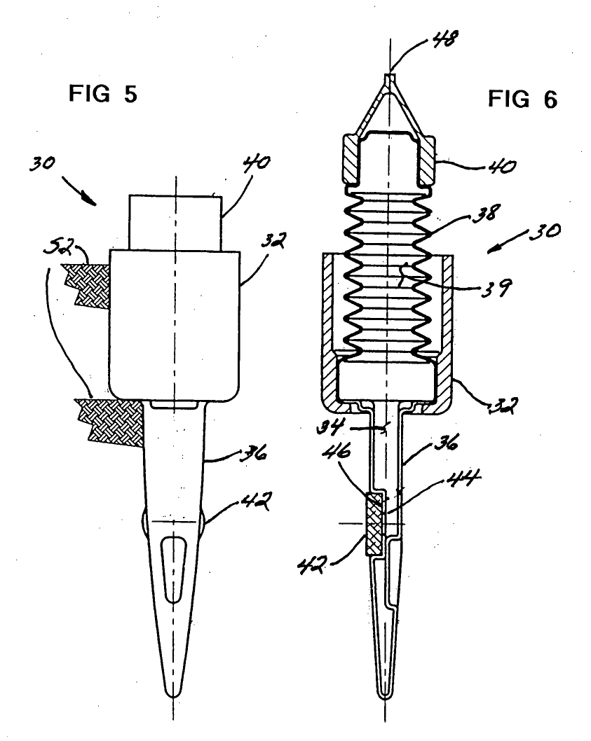

Referring now to the drawings, and firstly to FIGS. 1 to 4, a soil moisture monitoring apparatus 10 for monitoring the watering needs of potted plants and various other types of plants is there shown. Apparatus 10 comprises a housing 12 in the form of a flexibly resilient dome or bulb. This bulb 12 may be composed of assorted types of resilient plastic and also may comprise rubber or other natural materials. Typically, bulb 12 is injection molded. A suction chamber 14, which is at least partially evacuatable of air, is formed within bulb 12 as best seen in FIGS. 3 and 4. An annular rib 16 is formed circumferentially and unitarily about the bulb 12. A check valve in the form of a razor slit 18 is formed in the rib and in communication with interior chamber 14. An elongated indicator member 20 is carried by the upper end of bulb 12 and has a readily recognizable color such as red. Indicator element 20 may comprise a tubular element that is attached to the upper end of the bulb 12 or alternatively may be formed integrally with the bulb.

Still referring to FIGS. 1 to 4, a porous sensor 24 comprising a tubular ceramic member is attached to the lower end of bulb 12. In particular, ceramic sensor 24 includes a central opening 26 that communicates with the interior chamber 14 of bulb 12. Sensor 24 is received by the lower end of the bulb as best shown in FIGS. 3 and 4. The lower end of sensor 24 carries a pointed sensor tip 28, which may be composed of a suitable plastic.

In operation, apparatus 10 is planted in the soil adjacent to the plant or plants whose water moisture condition is being monitored. In particular, pointed tip 28 carried by sensor 24 is inserted into the soil S1 in the manner shown in FIG. 3. If necessary, the soil is watered (in some cases, the soil may already be sufficiently moist to meet the plants needs). The force of adhesion between the water and the soil is known as “soil moisture tension”. That force must be overcome for the plant to draw water out of the soil. As the plant requires water, its roots extract water from the soil by pulling it into the plant body by capillary action. It is known that a plant's roots can exert forces of 20 psig to draw water from the soil into the plant. As with the roots and the soil itself, the sensor 24 attracts moisture into its pores through capillary action. The pores are selected to correspond to a soil moisture tension of about 1 to 3 psig. At this level, the sensor 24 will hold water in its pores only when there is sufficient water in the soil for the roots of the plant to obtain water from the soil. When the soil is sufficiently dry that the roots encounter difficulty in extracting moisture from the soil, the soil moisture tension will typically exceed 3 psig and will therefore pull the moisture out of the pores of the sensor 24. This unplugs the pores of sensor 24 and allows air to enter through the pores into a central air passage 26 and suction chamber 14. As a result, apparatus 10 maintains the fully pressurized (i.e. atmospheric pressure) condition shown in FIG. 3.

Apparatus 10 is actuated for use in a manner shown in FIG. 4. With the sensor 24 inserted into soil S, cap 20 is pushed downwardly in the direction of the arrow to deflect the upper end of the bulb 12. Air within bulb 12 is at least partially evacuated through check valve 18 to create a vacuum, low pressure or suction region within chamber 14. When the soil is sufficiently moist to satisfy the needs of the plant, there is adequate moisture within the soil to be attracted by the capillary action of sensor 24 (e.g. the soil moisture tension is below 3 psig). As a result, the pores of the sensor remain plugged keeping air from passing therethrough from the soil into the air passage 26 and bulb 12 is held in the collapsed, low pressure condition. Check valve 18 remains closed and does not permit air to be pulled in through the slit.

Eventually, when the soil dries due to water being drawn into the roots of the plant or through evaporation, the pores of sensor 24 then also dry as the soil moisture tension exceeds 3 psig and moisture is pulled from the sensor 24 into the surrounding soil. Eventually, the pores unplug in the manner previously described and air enters the interior chamber 14. This increases the pressure in the bulb 12 to atmospheric pressure and causes the bulb 12 to reinflate such that the indicator cap 20 is projected upwardly in the manner shown in FIG. 3. This signals that the plant requires watering. After watering is performed, indicator 20 is pushed downwardly to return the apparatus to the condition shown in FIG. 4. Once again, the plugged pores of the sensor hold the bulb collapsed until the pores dry. This cycle may be repeated for as long as required so that timely indications are given when the plant requires watering.

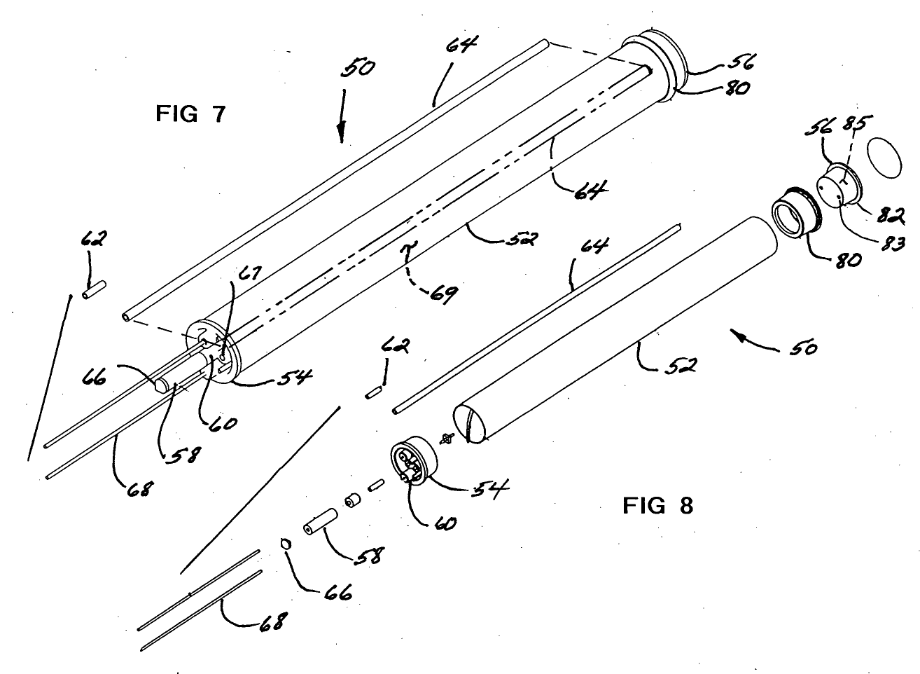

An alternative indicator 30 is shown in FIGS. 6 and 7. Indicator 30 comprises a plastic or metal support stand 36 and a cup shaped body 32, the stand 36 that depends from body 32. Body 32 nestably supports a bellows 38, which includes an interior vacuum chamber 39. The upper end of the bellows carries a duckbilled check valve 40.

A disk-shaped, porous sensor 42 is mounted on stake 36. A channel 44 communicably connects sensor 42 with an interior passageway 34 of stake 36. This passageway 34 is, in turn, connected to interior chamber 39 of bellows 38. Sensor 42 comprises a porous ceramic that attracts moisture through capillary action in a manner similar to the previously described embodiment. Once again, the pore size of element 42 is selected for a particularly desired soil condition. For dry or arid conditions, relatively small pore sizes are desirable; for moist or wet conditions, larger pore sizes are preferable.

In operation, stake 36 of apparatus 30 is inserted a desired depth into the soil S2. If the moisture level of soil is sufficiently high (which depends upon the size of the pores), the sensor 42 draws excess moisture from the soil into its pores until the sensor 42 is plugged. The user depresses or cocks the bellows into the nesting body. Air from chamber 39 is expelled through valve 40. Because the pores of the sensor are plugged, the bellows are maintained in the contracted or cocked condition. Eventually, as the soil dries, the soil moisture tension exceeds the level to which the sensor 42 is set (typically approximately 3 psig) and the soil then pulls the trapped moisture out of the pores of the sensor 42. Air is consequently transmitted through the sensor and into chamber 39. The bellows 38 “pops” or expands upwardly to indicate that the plant requires Additionally watering.

There is shown in FIGS. 7 and 8 a monitoring apparatus 50 that also waters the plant and its supporting soil as required. Apparatus 50 includes an elongated tubular housing 52 that is sealably enclosed by a lower base 54 and an upper cap 56. A porous ceramic sensor 58, analogous to the sensors previously described herein, is mounted to and depends from base 54. More particularly, sensor 58 is communicably connected to a channel 60, which extends through base 54. A connector 62 is communicably connected to channel 60 and extends upwardly from the interior surface of the base. An elongated tubular conduit 64 is communicably attached to connector inlet 62 and thereby sensor 58. Conduit 64 extends upwardly through interior chamber 69 of tubular housing 52. A second channel 67 also extends through base 54. An elongated dispensing hose (not shown) is attached to channel 70 and thereby communicates with the interior chamber 69. A pair of support stands 74 and 76 are attached to respective receptacles 78 and 80 formed in the bottom of base 54. These stands help to support apparatus 50 upright in soil S2.

Base 54 is plugged into or otherwise sealably attached to the lower end of tubular housing 52. Cap 56 is sealably and releasably engaged with tie opposite upper end of the tubular housing 52. In particular, cap 56 includes a plug portion 80 that is received in the upper end of the tubular housing 52 and a flange portion 82 that abuts the upper end of the housing 52. Plug includes an open interior cavity 85 and an orifice 81 that interconnects cavity 85 and the interior of chamber 69. The upper end of conduit 64 is open and terminates within cavity 85. Plug portion 80 has a relatively snug fit within the housing 52 such that the interior of this chamber 69 is sealed and effectively forms a vacuum or low pressure region when the cap 56 is attached. This supports a column of water to be supported within the closed tube as long as pores of sensor 58 remain plugged with moisture.

Apparatus 50 is deployed upright in soil. Stands 68 and sensor 58 are inserted into the soil. The dispensing hose (not shown) is attached to channel 70 and positioned proximate a plant (not shown) to provide a desired degree of watering. Cap 82 is opened and water is introduced into chamber 69. When soil contains adequate moisture to satisfy the plant, sensor 58 attracts sufficient moisture from the soil to plug its pores in the manner previously described. Accordingly, while cap 82 remains engaged with housing 52, a low-pressure region or vacuum is effectively formed within the upper end of chamber 69 above water. This supports the column of water within housing 52 and prevents water from being dispensed through hose 72.

Eventually, when soil dries sufficiently such that the soil attracts water out of the pores of ceramic sensor 58, air will pass through the sensor 58 and conduit 64 and then into the top of chamber 69 to allow water to be dispensed from channel 69 and the dispensing base. Once again, the rate of dissipation of water from the sensor 58 may be controlled by varying the size of the ceramic pores. When the water dissipates from the pores, air enters the ceramic sensor 58 and travels through channel 60, inlet 62 and conduit 64 into cavity 85 of plug 80. This effectively breaks the vacuum within the upper end of chamber 69. Water is thereby allowed to drain from chamber 69 through channel 60 and dispensing hose. Excess air pressure escapes from check part 83.

Eventually, the moisture of soil increases sufficiently such that the soil is adequately moistened and ceramic sensor 58 again attracts excess moisture into its pores through capillary action. This causes the pores to replug such that a vacuum is again created within the chamber to halt the flow of water through dispensing hose. In the foregoing manner, water is added to the soil automatically whenever the apparatus senses that additional water is required. Periodically, the tubular housing 52 may be replenished with water by simply opening cap 82 and adding additional fresh water into chamber 69.

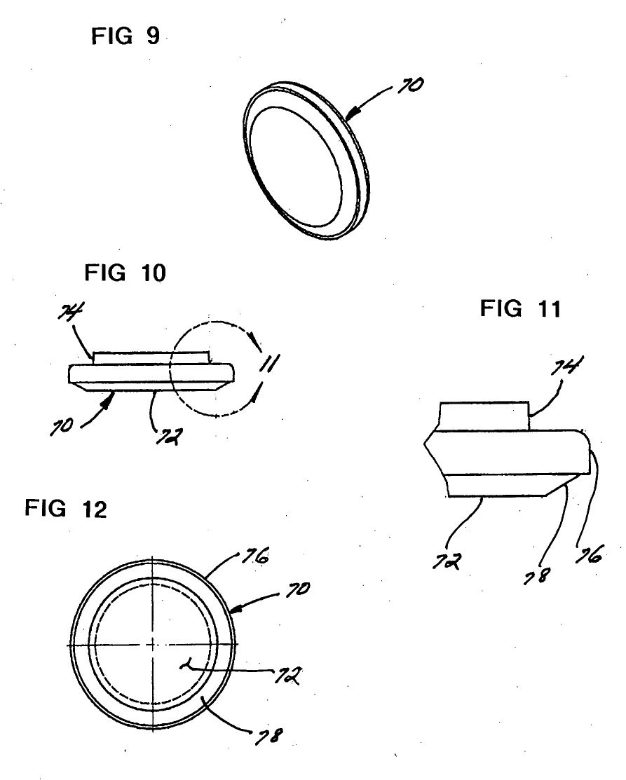

Referring now to FIGS. 9 to 12, the preferred embodiment of the sensor is there shown generally at numeral 70 and is formed of a permeable ceramic material that “wets”, i.e. has molecular attraction to water. As shown, the preferred configuration is in the form of a disc having a locator step 74 and a tapered exposed outer edge 78 which extends from the circular perimeter margin 76 to the generally flat front face 72.

The sensor 70 has openings defining the porosity thereof between contacting structural fragments that are limited to a distance of separation such that the molecular attraction of water bridges the openings and blocks air passages through the sensor 70. The preferred porosity that promotes healthy growth for most house plants was set to hold water in the structure until a pressure of 1.5 psig±0.7 psig (as determined by bubble testing) is applied across the thickness of the sensor 70. Water cannot be drawn through the sensor 70 because the head of the reservoir that acts on the sensor 70 is less than the set pressure for water to be pulled or pushed through the sensor 70. At 1.5 psig which corresponds to an equivalent value of soil moisture tension, a plant's roots need water. Testing and growth evaluation on the various plants was used to establish this negative pressure value. Other values outside this range are suitable. However, this setting provided the most desirable for producing the healthiest plants.

The sensor 70 functions as an “on/off” valve for incoming air. When the roots draw water out of the soil, moisture tension increases. Soil moisture tension is a measure of the negative pressure or suction that must be applied by the roots to acquire water out of the soil. Some plants are claimed to be able to pull up to two atmospheres or about 30 psig vacuum to draw water from the soil thereinto. When the level of soil moisture tension reaches 1.5 psig, water is extracted from the sensor 70 that is in surface contact with the soil. That is to say that the sensor 70 may be considered to be contiguous with the porous soil. When sufficient water is removed by soil moisture tension from sensor 70, an open air path through the sensor 70 will exist. At this point, atmospheric pressure allows air to penetrate the soil and pass through the sensor 70 to vent the sealed reservoir chamber of the apparatus in which the sensor 70 is operably placed. This allows water to flow out of the outlet tube from the water filled chamber and into the soil. The water migrates by capillary action through the soil and back to the sensor 70 and, when the moisture in the sensor 70 is sufficiently penetrated into the sensor 70, airflow is interrupted and water flow from the apparatus ceases. Thus the sensor 70 repeats this cycle of returning the air flow on and off and thereby controls the water flow from the apparatus and the plant is watered according to its needs with healthy timing.

This preferred embodiment of the sensor 70 is purchased from Homexx International of Corona, Calif. The ceramic material used is a proprietary ceramic designated G-2 which may be modified with a 10% walnut flower having a mesh size of approximately 325 and available under the trademark designation WF-5 from MS Abrasive Cleaning Equipment, Inc. of Yomalinda, Calif. The material is marbled in a tumbler and loaded in a die where it is compressed approximately 25% before being fired at a temperature of approximately 16000-1700° F. Preferably, a cereal binder may be added to the G-2 ceramic clay in an amount generally equal to 4% by weight of the total G-2 clay powder and used as a binder. This binder (available from Porter Warner #CB-201 4%) has a 200 mesh size and results in a porosity of the sensor of approximately 15 to 20 microns after being fired.

The total surface area is also established within a fairly narrow preferred range, the sensor having a minimum active area of about 0.1 in or 0.25 cm². The thickness of the active area is preferably held between about 0.12″ and 0.2″ or approximately 3 to 5 mm. Note that although any other shape, e.g. including a tubular configuration. The sensor 70 must be sealed or glued around the step area 74 into a mating cavity formed into the lower below ground stake portion of a watering apparatus which will be described more fully herebelow.

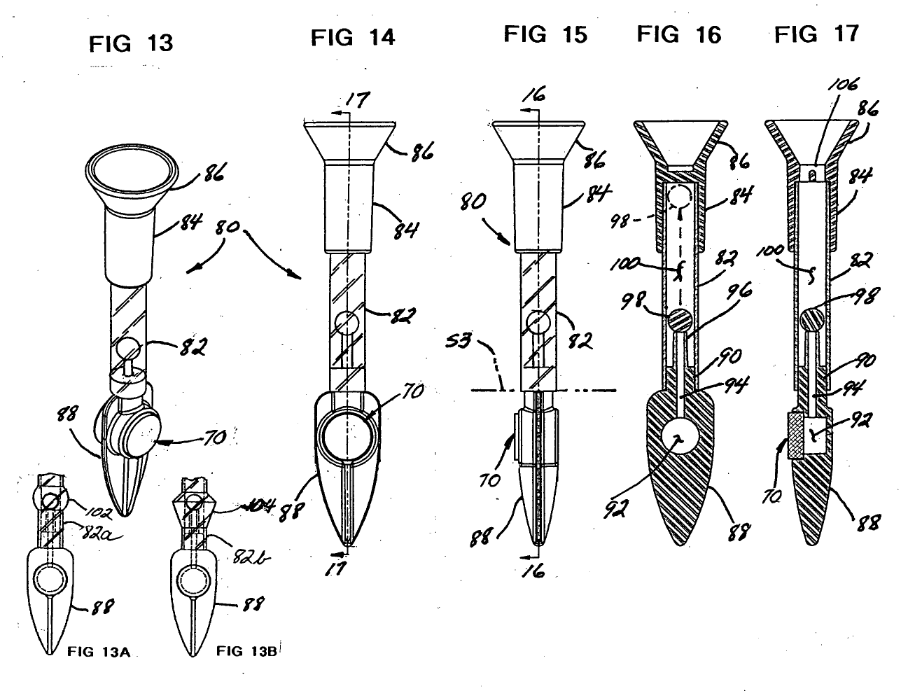

Referring now to FIGS. 13 to 17 and 13A and 13B, another embodiment of the invention which both monitors soil moisture level and limitedly waters the soil S3 shown at numeral 80. In this embodiment 80, an elongated tubular chamber 82 supports an upper cap 84 having a funnel 86 disposed at the upper end of the tubular chamber 82. Chamber 82 is preferably transparent so that the buoyant sealing ball 98 is viewable therethrough.

A funnel-shaped cap 84 is formed of opaque material and includes a funnel 86 for filling the chamber 82 through the base opening 106 which includes obstruction means for preventing the sealing ball 98 from floating up and out of the apparatus.

A stake 88 carrying a porous sensor 70 as previously described is connected to the lower end of the chamber 82 and includes an air passageway 94 from cavity 92, the upper end of passageway 94 being sealed by sealing ball 98 when in the downward position shown in solid in the drawings. The cycle of this apparatus begins by filling the chamber 82 with water as may typically occur during watering of the soil S3. When the soil is saturated or water-laden, water will be absorbed into the porous structure of the sensor 70. As the soil moisture tension increases during drying, water is pulled out from the sensor 70 as well as the surrounding soil. During this period, the sealing ball 98 as best seen in FIG. 16 is floating within the upper cap 84 and is not visible. However, a small amount of water will trickle outwardly through the sensor 70 into the soil to accomplish a distribution of a small amount of water into the immediately surrounding soil. When the water level in the chamber 82 drops sufficiently, a plant caretaker will again see the sealing ball 98 to be alerted that it is time to water the plant by hand and to simultaneously refill the chamber 82 through funnel 86.

Referring particularly to FIGS. 13A and 13B, two forms of lenses at 102 and 104 are provided to enhance the visibility of the sealing ball 98 when it gets to the bottom of its displacement and water within the chamber 82 is totally drained therefrom. Lens 102 magnifies the sealing ball image viewable through the transparent chamber 82 while lens 84 spreads out the color of the sealing ball 98 making it easier to view from above the soil surface.

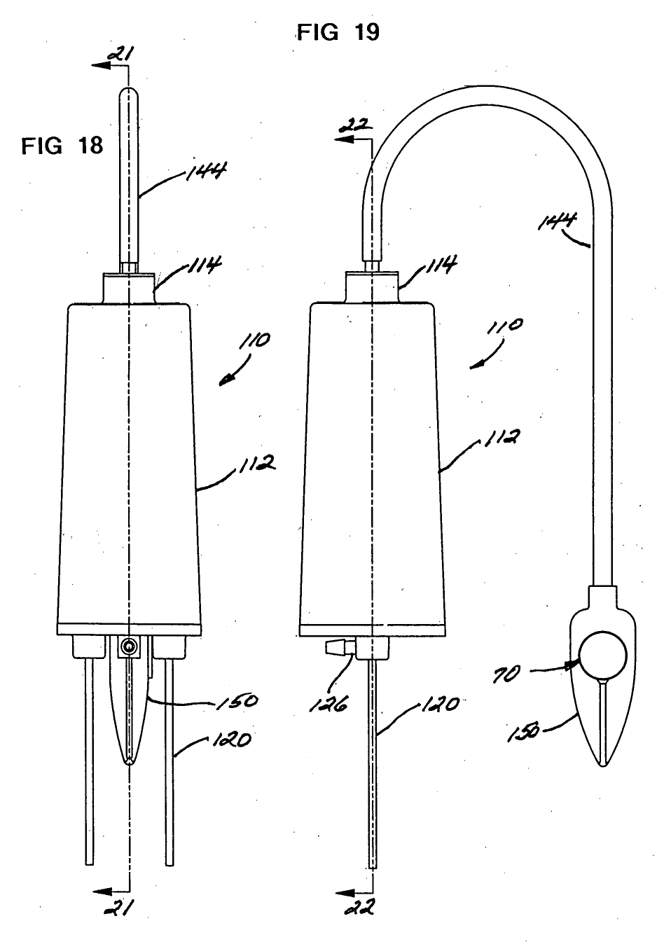

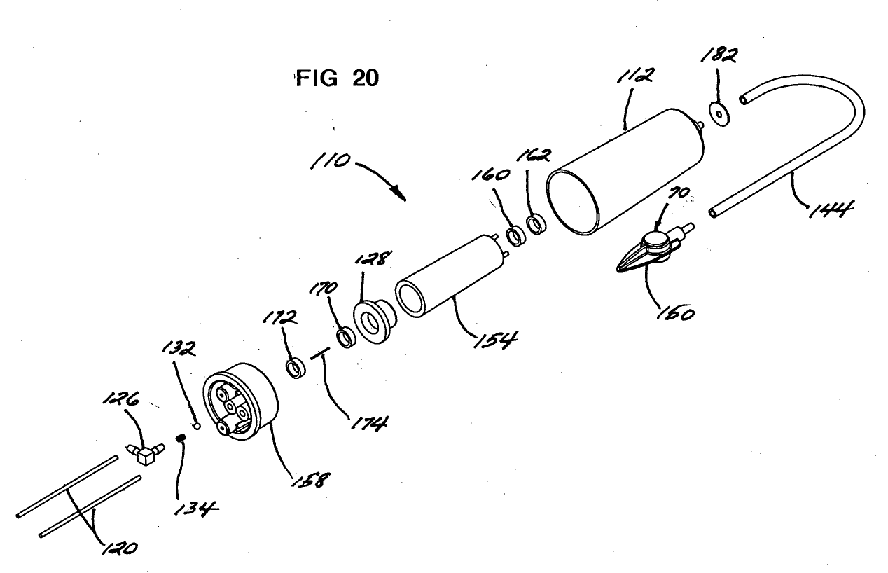

FIGS. 18 to 25 depict still another version of the monitoring and watering apparatus shown generally at numeral 110 which again includes a tubular or cylindrical housing 112. It should be noted that the shape of the housing in any of the embodiments of this invention may be varied within the scope of the invention. Housing 112 carries a molded upper support member 114 and a lower support member 116 that is fixedly attached to the cylindrical housing. A pair of lower support stakes 120 are carried by lower support 116 for supporting apparatus 110 in soil S4.

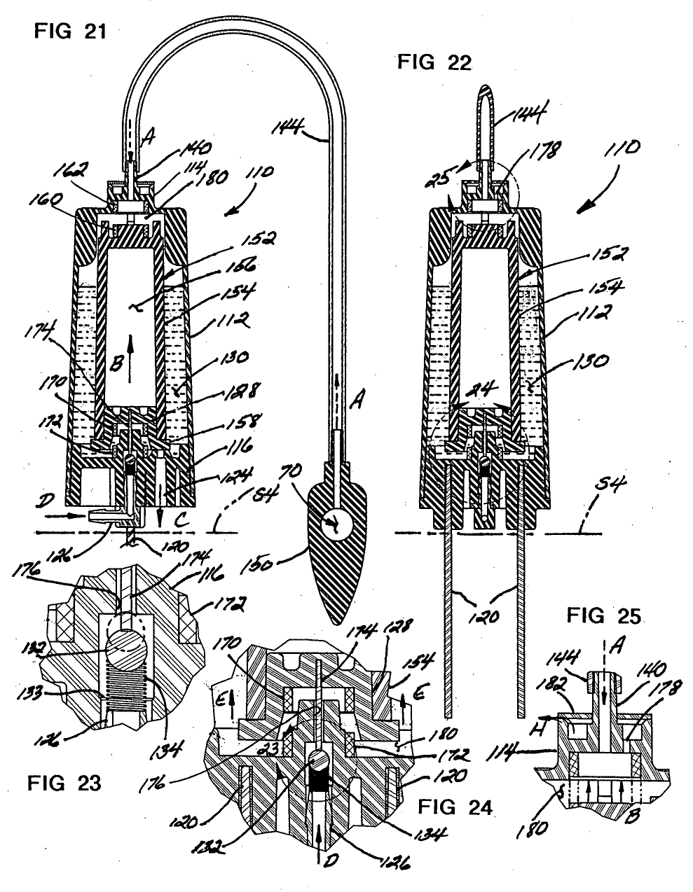

The interior construction of apparatus 110 is best shown in FIGS. 21 to 25. In particular, lower support 116 carries a dispensing outlet 124. A water inlet fitting 126 is connected to a lower end of lower support 116. The inlet fitting is connected to a water supply such as a gravity feed container, a regulated pressure source or a pump (not shown). An inlet valve assembly 128 permits water from this water source to be introduced through fitting 126 into the interior chamber 130 of cylindrical housing 112 as required. Valve assembly 128 includes an inlet ball valve 132 and a return spring 134 best seen in FIG. 24 that releasably hold the ball valve 132 in a closed condition sealed against lower support 116 to prevent water from being introduced through the lower support into the housing chamber 130. The return spring is seated upon inlet fitting 126. Upper support element 114 includes a sensor inlet fitting 140 and a check valve disc 182. The sensor inlet fitting 140 is connected through an elongated flexible tube 144 to a ceramic sensor 70 sealingly attached to a stake 150 in a manner previously described herein whereby the sensor 70 is in airtight communication with the interior of the tube 144 and the upper portion 180 of chamber 130.

A float element 152 is mounted in chamber 130 between upper and lower support members 114 and 116. Float element 152 includes a cylindrical body 154 and a lower insert portion 158 that carries ball valve 132. The upper end of float element 152 carries an upper ring-shaped magnet 160, which is selectively interengagable with complementary upper ring-shaped magnet 162 carried by upper support 114. Likewise, the insert 158 of float element 152 and lower support 116 include respective, a complementary set of lower magnets 170 and 172. The corresponding upper and lower magnet pairs permit the float element 152 to be held in provisional, snap-action attachment to either the upper support or the lower support during operation of the apparatus 110 as shown by arrow B.

Apparatus 110 is connected to a relatively low pressure water supply (not shown) at inlet fitting 126 to introduce water into the apparatus 110 in the direction of arrow D. When chamber 130 is empty, or nearly empty, and float 152 is in a lowered position within chamber 130, the lower pairs of magnets 170 and 172 attract and interengage one another to hold the float in the lower position. In this position, the ball valve is open (i.e. unseated from the lower support) by shaft 174 attached to lower support member 116 and water is introduced at low pressure through the open valve shown in solid lines in FIG. 23 into the chamber 130 through longitudinal passage 174 and in the direction of arrows E in FIG. 24. If excessive water pressure is introduced, this will force the ball valve 132 to close. As a result, a “failsafe” operation is achieved. This provides regulated, low pressure water to chamber 130.

Apparatus 110 is mounted in the soil in a manner similar to the previously described embodiments. Particularly, supports 120 are inserted into the soil 54 proximate the plant to be monitored and sensor 70 sealingly attached to spike 150 is likewise inserted into the soil at a desired placement. Initially, the chamber 130 is filled sufficiently with water to raise the level of float 152 until the upper magnet sets 160 and 162 operably interengage and hold the float in an elevated condition. If sufficient moisture is contained in the soil to satisfy the plant, the pores of sensor 70 absorb water and are plugged. This creates at least a partial vacuum within the region 180 of chamber 130 above the water level. As a result, water is not allowed to drip from dispensing outlet 124. The plant thereby utilizes the water already in the soil.

Gradually, the plant dissipates the available water from the soil S4 and the soil dries sufficiently such that it pulls the water from the pores of sensor 70. This unplugs the pores and allows air to enter chamber region 180 in the direction of arrow A. The partial vacuum within the chamber 130 is broken and, as a result, water is dispensed from the apparatus 110 through dispensing outlet 124 in the direction of arrow C into soil S4 and the water level within chamber 130 gradually drops. Eventually, the weight of float 152 causes a break of magnetic contact with upper support 114 and the float 152 drops within housing 112 until the lower end of the float 152 approaches lower support member 116. Lower magnets 170 and 172 eventually attract one another and the float 152 is pulled by snap action into engagement with the lower support member 116. This urges the ball valve 132 to open so that low pressure water is again introduced into the chamber 130. The water level rises and the buoyancy of the water thereby returns the float 152 to its raised condition where it magnetically interengages the upper support 114. At that point, the ball valve is closed so that no further water is added. At about the same time, sufficient water should be dispensed through outlet 124 so that the soil is sufficiently moistened and the pores of sensor 70 become replugged. As a result, a vacuum is effectively formed and the dispensing of water is halted. Apparatus 110 may continuously cycle in the foregoing manner so that water is provided to the soil only as required. This embodiment 110 features the further advantage that water under low pressure is continuously provided to the apparatus. The apparatus does not require manual refilling.

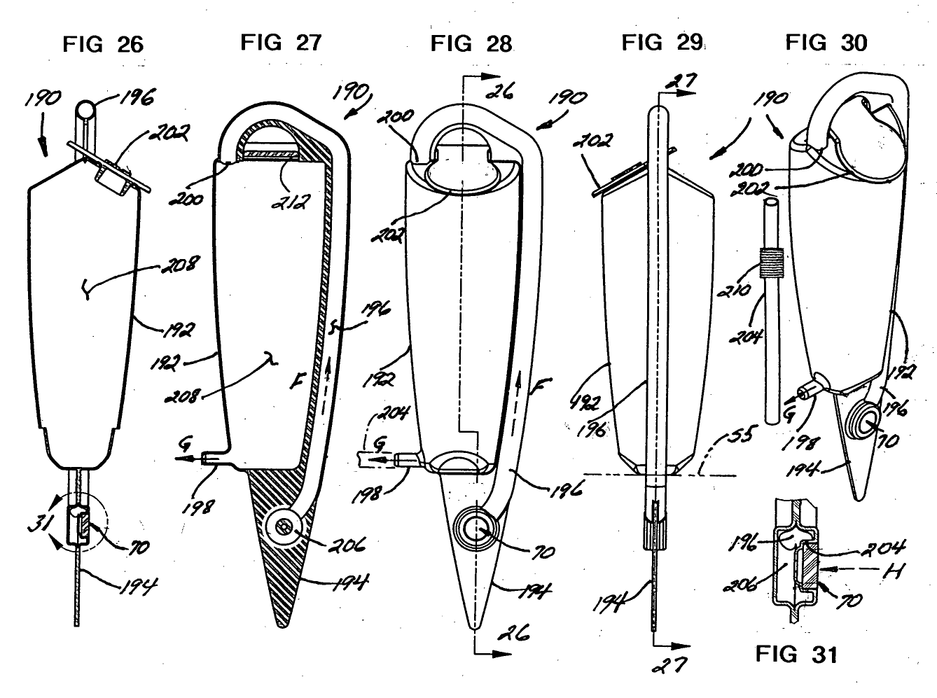

The apparatus shown in FIGS. 26-31 generally at 190 utilizes principles analogous to the previously described embodiment and includes only 4 parts, 3 of which are preferably composed of a durable plastic. A water container 192 defines an interior cavity 208 that accommodates water and an integrally molded tube or channel 196 which communicably connects the interior 208 of container 192 with a sensor 70 as previously described. Sensor 70 is mounted within a recess 204 of a ground spike 194 molded integrally with the container 192. By molding the channel 196, the spike 194 and recess 204 for sensor 70 integrally with container 192, the number of parts are reduced and the cost of the item is lowered considerably. In addition, the design provides for a very pleasant and easy to hide shape. Apparatus 190 is expected to be a transparent or translucent green color.

A water inlet 212 is provided in the top of container 192 to introduce water into the container. This water inlet 212 is selectively and sealably closed by a plug 202 that is attached by ears or a projection to the top of the container. Plug 202 may be selectively and sealably closed and opened with respect to the water inlet 212 as required.

A molded, restricted outlet 198 is formed proximate the lower end of container 192. A restricted outlet of approximately 0.08 inches in diameter is formed or molded into the end of the outlet 198 to keep the water from escaping too fast while filling the container. The restriction also makes the outlet hole small enough so that air cannot travel beside the water that is flowing through the outlet 198. Thus, only water can flow in the direction of arrow G.

Apparatus 190 operates in the following manner. An outlet tube 204 having an accordion-style extension 210 is attached to outlet 302. Spike 194 is inserted into the soil S5 in the vicinity of a plant to be watered. When there is sufficient water in the soil S5, sensor 70 is blocked by the water held within its porous ceramic structure so that air cannot penetrate the chamber 208 through tube 196 and water is held within chamber 208 of container 192. No water is allowed to drain from outlet 198. Alternatively, when the soil is dry, air enters tube 196 through cavity 206 from sensor 70 in the direction of arrow H and the resulting increased air pressure within the container 192 allows the water to drain through outlet 198 in the direction of arrow G and from outlet tube 204 into the plant area to be watered.

The foregoing apparatus operates analogously to the manner in which water is held within a drinking straw. If a person holds a finger over the end of the straw, and the straw is held upright, water cannot escape from the lower end of the straw. However, when the person's finger is removed from the upper end of the straw, this permits air to enter the straw so that the straw is drained of water.

Plug 202 is both airtight and watertight and is easily flipped up and retained beside the water filler inlet hole by either a single projection, or a pair of ears carried by the plug 202. After filling the container 192, the plug is ready to be inserted back into the inlet hole. An alternative construction is for the plug to be spring loaded upwardly so that it opens automatically, thereby allowing the container 192 to be filled with water. After the container 192 is filled, the plug is held briefly until the water develops enough pressure to hold it down.

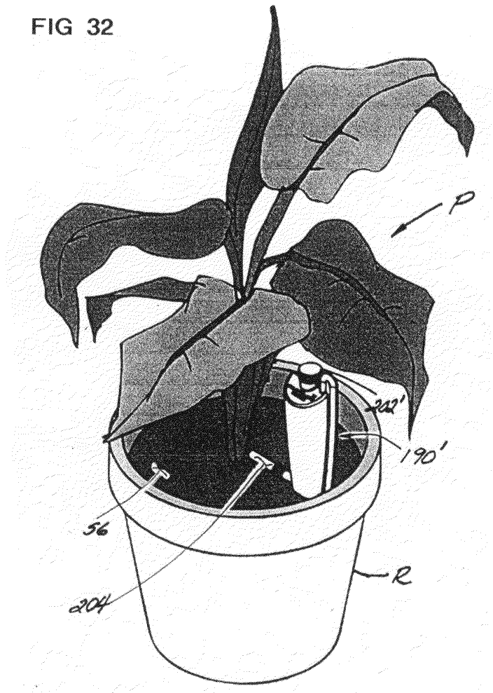

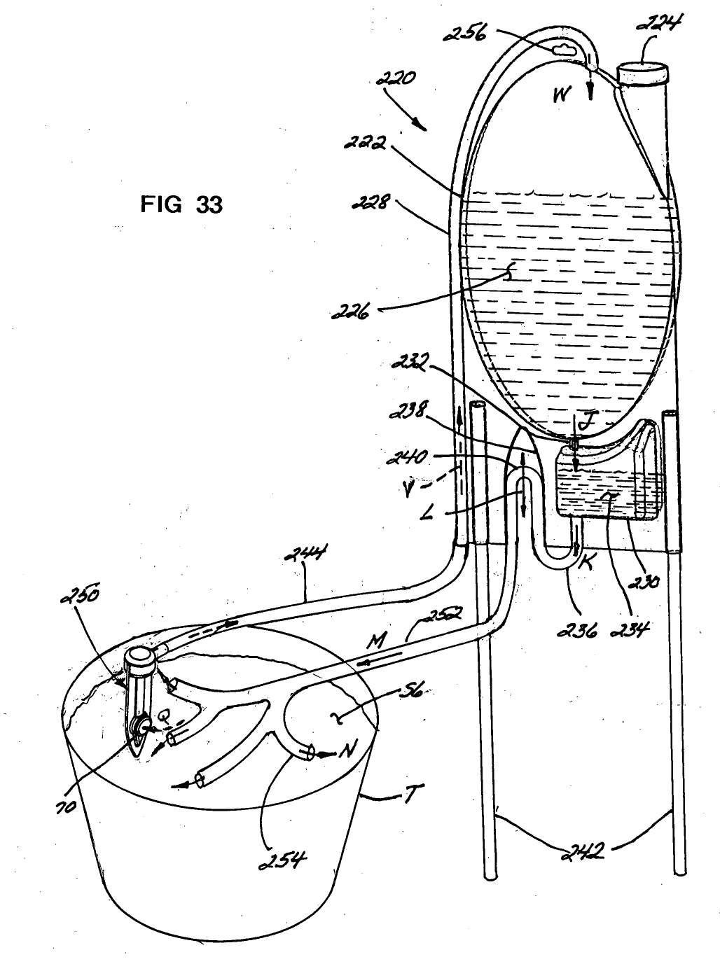

Referring now to FIG. 32, an alternate embodiment of the invention previously described in FIGS. 26 to 31 is there shown generally at numeral 190′. This embodiment 190′ is substantially identical to embodiment 190 except that a screw cap 202′ is provided in lieu of the resilient plug 202 previously described. This embodiment 190′ is shown embedded within soil S6 within a planting pot R adjacent the plant P to be watered.

Referring lastly to FIG. 33, another embodiment of the invention is there shown generally at numeral 220 which incorporates a siphon overflow surge tank 230 coupled to and positioned below a main water chamber 222. After the main chamber 222 has been filled with water at 226 through the sealable opening 224 and the soil S6 within planter T has become sufficiently moist so as to plug the flow of air through the sensor 70 of the soil spike 250 as previously described, the water 234 contained within the siphon tank 230 is there held without leakage or distribution therefrom.

As previously described, when the sensor 70 becomes sufficiently dried of moisture to allow air to pass therethrough in the direction of arrow Q, the air flow continues in the direction of arrow V within a molded air passage 228 formed as an integral part of the water chamber 222 and siphon tank 230. The air is drawn into the interior of main chamber 222 in the direction of arrow W whereupon water is allowed to be distributed into the siphon tank at 234 in the direction of arrow J through connecting tube 232. When sufficient water has been distributed into the siphon tank 234 to reach a height sufficient to fill the upper portion of the siphon loop 240 of flexible conduit 236, water will then begin to flow by siphon action in the direction of arrow M for distribution through all of a plurality of tubular outlets 256 in the direction of arrow N typically. Because the siphon action has started, virtually all of the water 234 within the siphon tank 230 will be distributed very quickly and will more uniformly and effectively saturate the soil S6 whereupon moisture will find its way into the sensor 70 to interrupt air flow and essentially interrupt water flow from the main water chamber 222 through the connecting conduit 232 until the next dryness cycle.

Note that the siphon loop 240 is adjustable in height in the direction of arrow C within a molded cavity 238 of this apparatus 220 to vary the amount of water required to be contained within the siphon tank 230 before the siphon action will begin to water the soil S6. Thus, the siphon tank 230 will be automatically filled by water 226 from the main chamber 222 to a height controlled by the height of the top 240 of the siphon tube.

From the foregoing it may be seen that the apparatus of this invention provides for an apparatus for monitoring soil moisture and more particularly to an apparatus for sensing when the soil supporting a plant requires monitoring. While this detailed description has set forth particularly preferred embodiments of the apparatus of this invention, numerous modifications and variations of the structure of this invention, all within the scope of the invention, will readily occur to those skilled in the art. Accordingly, it is understood that this description is illustrative only of the principles of the invention and is not limitative thereof.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. A soil moisture sensing and watering apparatus comprising:
an elongated soil spike;
a porous moisture sensor carried on said soil spike for blocking the passage of air therethrough when moist;
a housing carried on an upper end of said soil spike and having a sealable opening for filling said housing with water;
said moisture sensor capable of absorbing a quantity of moisture from soil;
an air passage connecting an interior surface of said moisture sensor with the interior of said housing above the water level of the housing;
a water outlet formed at a lower end of said housing for dispensing water from said housing atop the ground or soil into which said spike is inserted;
said moisture sensor having porosity sufficient to allow air from the soil to pass therethrough into said air passage and the interior of said housing when the soil moisture tension exceeds a predetermined level due to soil dryness and moisture buildup in said sensor is drawn into the soil.

2. A soil moisture sensing and watering apparatus as set forth in claim 1 wherein:
said outlet is sized in the range of about 0.06″ in diameter whereby air cannot enter into the interior of said housing when water is flowing from said outlet.

3. A soil moisture sensing and watering apparatus as set forth in claim 1 wherein:
said soil spike carrying said moisture sensor is separate from said housing and operably connected thereto by a flexible air conduit.

4. A soil moisture sensing and watering apparatus as set forth in claim 1 wherein:
said moisture sensor has a porosity sized to pass air therethrough in the pressure range of 1.5 psig±0.7 psig across the thickness of said moisture sensor.

5. A soil moisture sensing and watering apparatus as set forth in claim 1, wherein:
said moisture sensor has a porosity size in the range of 15 to 20 microns for proper air volume passage therethrough when said moisture sensor becomes substantially dry of moisture.

6. A soil moisture sensing and watering apparatus as set forth in claim 1, wherein:
said moisture sensor has a thickness in the range of 0.1 to 0.2 in and an active surface area of at least about 0.2 in².

7. A soil moisture condition sensor and watering apparatus comprising:
a rigid soil spike carrying a porous moisture sensor on said spike so as to place said sensor in contact with the soil and near the root regions of a plant when said spike is inserted into the soil;
said sensing device composed of a non-organic, capillary type material having a plurality of pores of predetermined diameter wherein said sensor acts as an air valve to restrict air movement from the soil through said sensor when the soil in contact therewith has reached a predetermined high moisture level within the soil has closed said pores and to permit the passage of air from the soil through said sensor when the soil has reached a predetermined low moisture level;
a housing carried on the other end of said spike, said housing having a water inlet for controlledly receiving water from a low-pressure water supply for substantially filling said housing with water;
a water outlet on a lower end of said housing;
said sensor and said housing operably connected to maintain or release a pressure differential therebetween responsive to the predetermined soil moisture levels wherein water in said housing is maintained or released from said water outlet.

8. A soil moisture sensing and watering apparatus as set forth in claim 7, wherein:
said outlet is sized in the range of 0.06″ in diameter whereby air cannot enter into the interior of said housing when water is flowing from said outlet.

9. A soil moisture sensing and watering apparatus as set forth in claim 7, wherein:
said soil spike carrying said moisture sensor is separate from said housing and operably connected thereto by a flexible air conduit.

10. A soil moisture sensing and watering apparatus as set forth in claim 7, wherein:
said moisture sensor has a porosity sized to pass air therethrough in the pressure range of 1.5 psig±0.7 psig across the thickness of said moisture sensor.

11. A soil moisture sensing and watering apparatus as set forth in claim 7, wherein:
said moisture sensor has a porosity size in the range of 15 to 20 microns for proper air volume passage therethrough when said moisture sensor becomes substantially dry of moisture.

12. A soil moisture sensing and watering apparatus as set forth in claim 7, wherein:
said moisture sensor has a thickness in the range of 0.1″ to 0.2″ (in.) and an active surface area of at least about 0.1 in.²

13. A soil moisture sensing and watering apparatus as set forth in claim 9, further comprising:
a float positioned within said housing and a water inlet flow control valve positioned at a lower end of said housing adjacent said water inlet;
said float moving to a downwardly position in said housing and opening said flow control valve when said housing is substantially empty of water;
said float moving to an upwardly position in said housing and closing said flow control valve when said housing is substantially filled with water;
magnet means positioned at each end of the interior of said housing and said float and arranged to positively hold said float in said downwardly or said upwardly position.

14. A moisture sensing and watering apparatus comprising:
a porous moisture sensor carried on a soil spike insertable into soil;
said sensor coming in contact with, and absorbing moisture from, soil into which said soil spike is inserted;
a housing for holding a quantity of water within an airtight sealed or sealable interior or chamber thereof;
said sensor blocking airflow therethrough when sufficient moisture is held within the porous structure thereof;
said sensor having porosity sufficient to allow air from the soil to pass therethrough into the interior or chamber of said housing when the soil moisture tension exceeds a predetermined level due to soil dryness and moisture buildup in said sensor is drawn into the soil thereby releasing water into the soil from said housing through a water outlet formed at a lower end of said housing;
said outlet is sized sufficiently small in diameter to prevent air from entering into the interior of said housing when water is flowing from said outlet.

15. A moisture sensing and watering apparatus as set forth in claim 14, wherein:
said moisture sensor has a thickness in the range of 0.1 to 0.2 (in.) (2.5 to 5.0 mm).

16. A moisture sensing and watering apparatus as set forth in claim 15, wherein:
said moisture sensor has a porosity sized to pass air therethrough in the pressure range of 1.5 psig±0.7 psig across the thickness of said moisture sensor when said sensor is water saturated or one surface thereof is submerged in water.

17. A moisture sensing and watering apparatus as set forth in claim 16, wherein:
said moisture sensor has a porosity size in the range of 15 to 20 microns for proper air volume passage therethrough when said moisture sensor becomes substantially dry of moisture.

18. A moisture sensing and watering apparatus as set forth in claim 14, further comprising:
a secondary siphon tank operably positioned between said chamber and said outlet;
said siphon tank receiving water from said chamber and substantially emptying said siphon tank of water from said outlet when a predetermined water level in said siphon tank is reached.
